(19) United States
(12) Patent Application Publication
(10) Pub. No.: US 2010/0211449 A1
(43) Pub. Date: Aug. 19, 2010

(54) GAMING SYSTEM AND METHOD

(76) Inventor: Joan Nelson, Sydney (AU)

Correspondence Address: DICKSTEIN SHAPIRO LLP, 1825 EYE STREET NW, Washington, DC, 20006-5403, US

(21) Appl. No.: 12/738,812

(22) PCT Filed: Oct. 15, 2008
(86) PCT No.: PCT/GB08/03517

§ 371 Date: Apr. 27, 2010

(30) Foreign Application Priority Data
Oct. 17, 2007 (EP) 0720338.3

(51) Int. Cl. G06Q 30/00; A63F 9/24; G06Q 10/00; G06Q 50/00

(52) U.S. Cl. 705/14.25; 463/25; 705/14.26; 235/375

(57) ABSTRACT

A computer implemented system for providing customers of retail outlet(s) with a transaction based gaming reward. There is a point of sale at a retail outlet (2) such as a supermarket check-out. There is a POS device (3) which runs POS software which also runs the application for production of a ticket, coupon or receipt with a reward to be offered to the customer making the transaction. To this end, the POS device (3) and its software stores text and image(s) required for production of a required reward via the ticket, coupon or receipt. The application software for the reward may control what is displayed on the pole display. There is a scanner (4) at the point of sale 1 which scans the or each item (5) purchased, which scanner (4) triggers the application to inspect the text being sent to the POS screen (6). The point of sale (1) also includes a printer (7) which is a dedicated printer device which prints out a ticket, coupon or receipt bearing the reward offered to the customer, which reward is determined by the application and which can be triggered to activate the dedicated printer (7) to print out the ticket, coupon or receipt at any time during the POS transaction. The reward can be offered at a first characteristic of a transaction, all characteristics of a transaction, or at any number of characteristics between one and all characteristics.

The invention relates to a gaming system and method, and particularly to a computer-implemented system and method for providing customers of retail outlet(s) with a transaction based gaming reward.

Customers of a retail outlet usually complete a transaction at a point of sale (POS) of that outlet. The transactions are usually completed electronically, details of the transaction, including profiles thereof are stored in a central database, but are often not thereafter utilised. It is also a fact that gaming via gaming apparatus is becoming more prevalent, particularly gaming in or at a location such as a casino (though other locations can also be envisaged, such as on concourses at airports, railway stations, bus stations, ferry terminals and games' parlours). The games are played for reward, but often there is no initial incentive for a potential player of such apparatus to play the gaming apparatus. Part at least of the reason for this is that a gaming machine operator has no data, except for existing loyalty card-holders, on which to base such an incentive, or reward, for playing the apparatus. In other words, there is usually no criterion on which the level of incentive can be pitched.

It is an object of the invention to seek to mitigate this disadvantage.

According to a first aspect of the invention there is provided a computer-implemented system for providing customers of retail outlet(s) with a transaction based gaming reward, comprising means for respectively determining details of a customer transaction and providing a reward to the customer, means associated with a gaming apparatus for checking validity of a reward presented by a customer, and means for determining the level of reward based at least on analysis of transaction data.

Using the invention it is possible to determine which reward will result in optimum casino spend, particularly when the level of reward also takes account of reward attributes and redemption behaviour.

The system may comprise a network of said means.

The reward may be printed on an item selected from a group comprising a ticket, coupon and receipt (unless these are one and the same) issued at the point of customer transaction. This provides a relatively simple, user-friendly system.

The means for determining the level of reward may provide mapping of rewards based initially on retail outlet (or point of purchase) location and selected transaction attributes, whereby to provide an offer of a reward based on predictive gaming apparatus spend.

The retail outlet may include at least one point of sale at which the reward may be issued to the customer. Thus the system may include a plurality of POS.

There may be a plurality of separate retail outlets each of which may have at least one point of sale at which the reward may be issued to the customer.

This provides for a comprehensive system.

The at least one point of sale may comprise a printer adapted to print a ticket, coupon or receipt bearing details of the reward.

The details of the reward may be encoded in a bar code, or in a magnetic strip. These alternatives provide for flexibility in application.

The printer may be adapted to print a ticket, coupon or receipt at any point during a transaction at the point of sale. This provides for flexibility in generation of an award.

The existing point of sale may comprise the said printer as an additional printer dedicated to the provision of a ticket, coupon or receipt.

The point of sale may comprise a scanner device adapted to initiate means at the point of sale for providing the reward to the customer.

The point of sale may comprise a screen device associated with the said means for determining the display to be displayed on a pole device (virtual or otherwise).

The point of sale may comprise a device adapted to run a basic application and comprising an accessible drive adapted to hold text and image(s) required to produce an appropriate ticket, coupon or receipt.

The accessible drive may be adapted to produce a plurality of offers of rewards predetermined by the means for determining the level of reward.

The system may be adapted, for each transaction, to print an offer of a reward based solely on a first transaction characteristic of a reward.

Alternatively, the system may be adapted, for each transaction, to print an offer of a reward based on a plurality of transaction characteristics of a reward.

The plurality may comprise all of the transaction characteristics of the reward. Thus the characteristics determining the reward to be offered may cover a number of characteristics of the transaction from one to all. This provides for flexibility of the system, and provides for control of the awards by an operator of the gaming apparatus, which may be located at or in a casino, or which may be applicable to one or a plurality of casinos, possibly remote from the retail outlet(s), at the or each of which casinos there is preferably a gaming device adapted to be played using the reward.

The or each gaming apparatus may be electronic and adapted to be played using the reward.

The gaming apparatus may include electronic means to read the bar code or magnetic strip whereby to load a valid offer of a reward into the gaming apparatus for play by the customer.

The gaming apparatus may comprise means to track the in-casino spend of the customer redeeming the reward.

The gaming apparatus may include means to determine a cash total won and to issue an appropriate ticket which may then be used in another gaming apparatus.

The said means may provide a printed ticket identifying the cash amount won and the value encoded from the reward offered at the point of sale.

According to a second aspect, the invention provides a method of providing a computer-implemented system for providing customers of retail outlet(s) with a transaction based reward, comprising the steps of providing a point of sale and means for respectively determining details of a customer transaction and providing a reward to the customer, providing a gaming apparatus and means associated therewith for checking validity of a reward presented by a customer, and providing means for determining the level of reward to be offered based at least on details of the transaction.

A system and method embodying the invention are hereinafter described, by way of example, with reference to the accompanying schematic drawings.

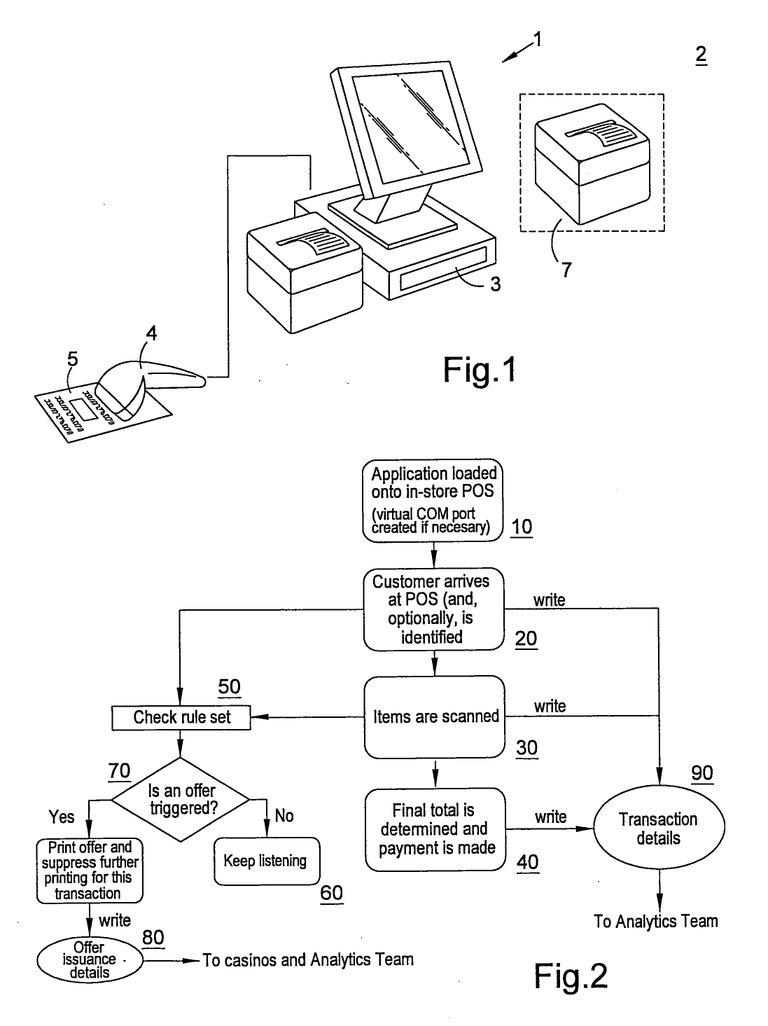

FIG. 1 shows schematically a point of sale for use in a system and method according to the invention;

FIGS. 2 to 4 show respectively a flow chart of the system and method at a POS, a gaming apparatus and a location for determining reward characteristics; and

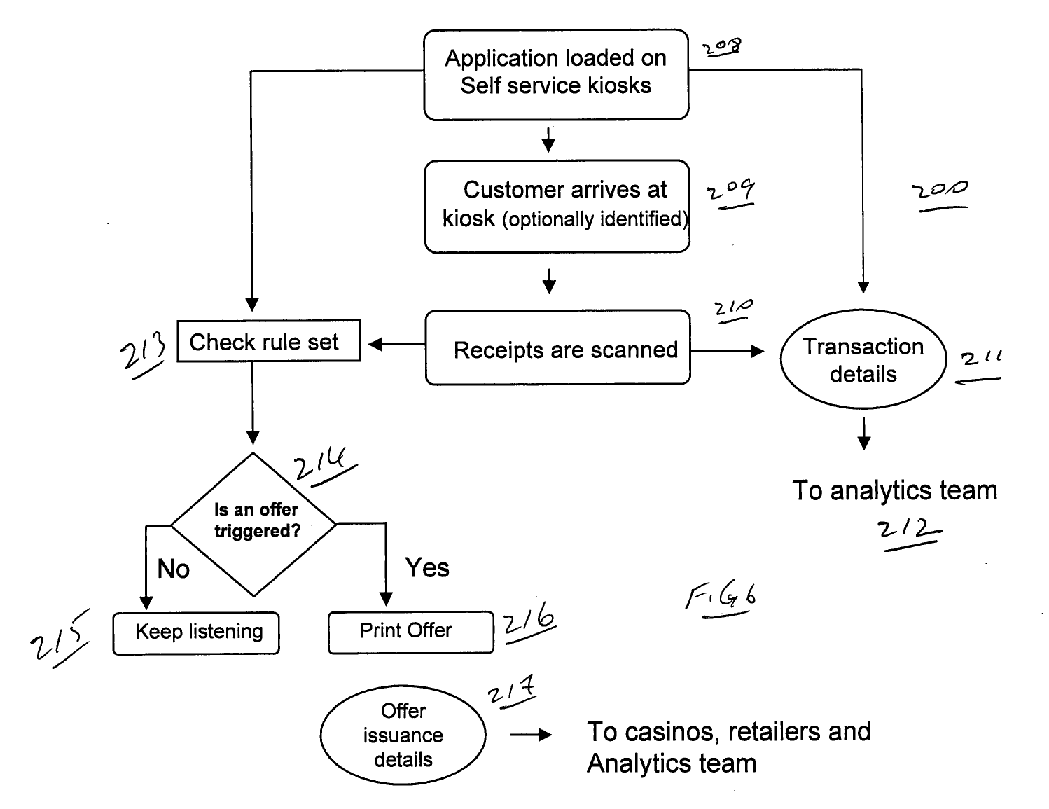

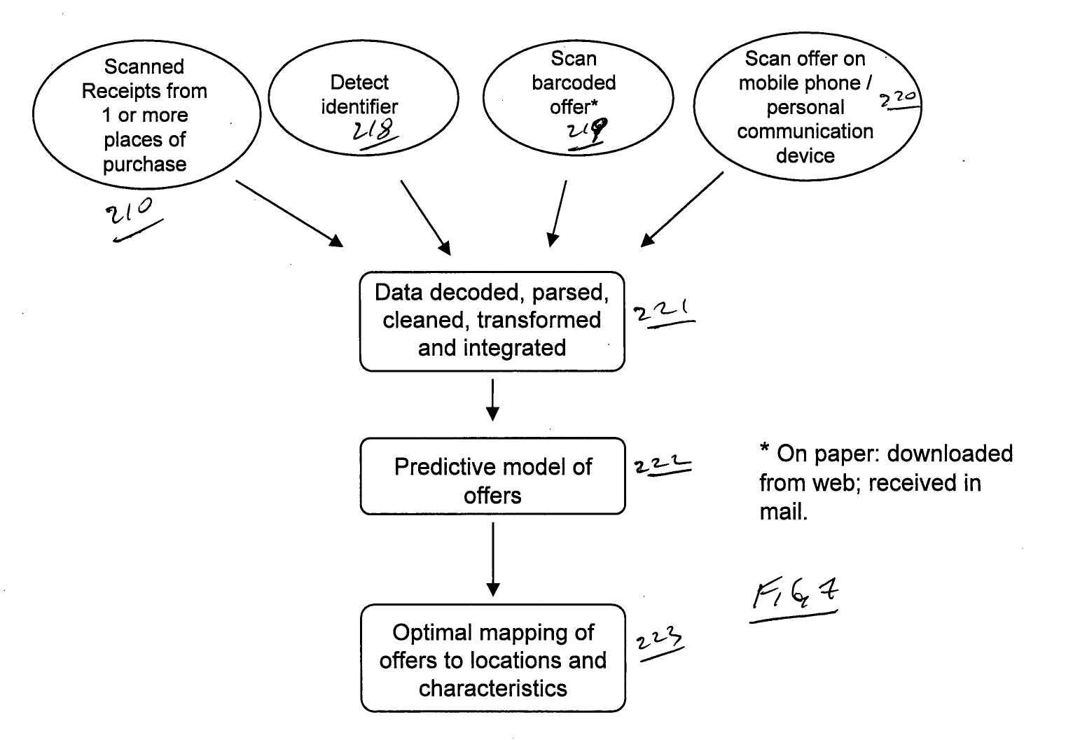

FIGS. 5 to 7 show respectively flow charts for information processing using a kiosk (FIG. 5), applications of information from kiosks (FIG. 6), and optional use of data (FIG. 7)

Referring to the drawings FIG. 1 shows a point of sale (POS) 1 at a retail outlet 2 such as a supermarket check-out, (it being understood that there may be more than one POS in the outlet, and moreover that there may be a plurality of such retail outlets 2, which are remote from one another).

There is a POS device 3 which runs POS software (for monitoring and determining the transaction) which also runs the targeted application for production of a ticket, coupon or receipt with a reward to be offered to the customer making the transaction. To this end, the POS device 3 and its software also stores text and image(s) required for production of a required reward via the ticket, coupon or receipt.

The application software for the reward may optionally control what is displayed on the pole display. There is a scanner 4 at the point of sale 1 which scans the or each item 5 purchased, which scanner 4 triggers the application to inspect the text being sent to the POS screen 6. The point of sale 1 also includes a printer 7 which is a dedicated printer device which prints out a ticket, coupon or receipt bearing the reward offered to the customer, which reward is determined by the application and which can be triggered to activate the dedicated printer 7 to print out the ticket, coupon or receipt at any time during the POS transaction. Thus the reward can be offered at a first characteristic of a transaction; all characteristics of a transaction, or at any number of characteristics between one and all characteristics.

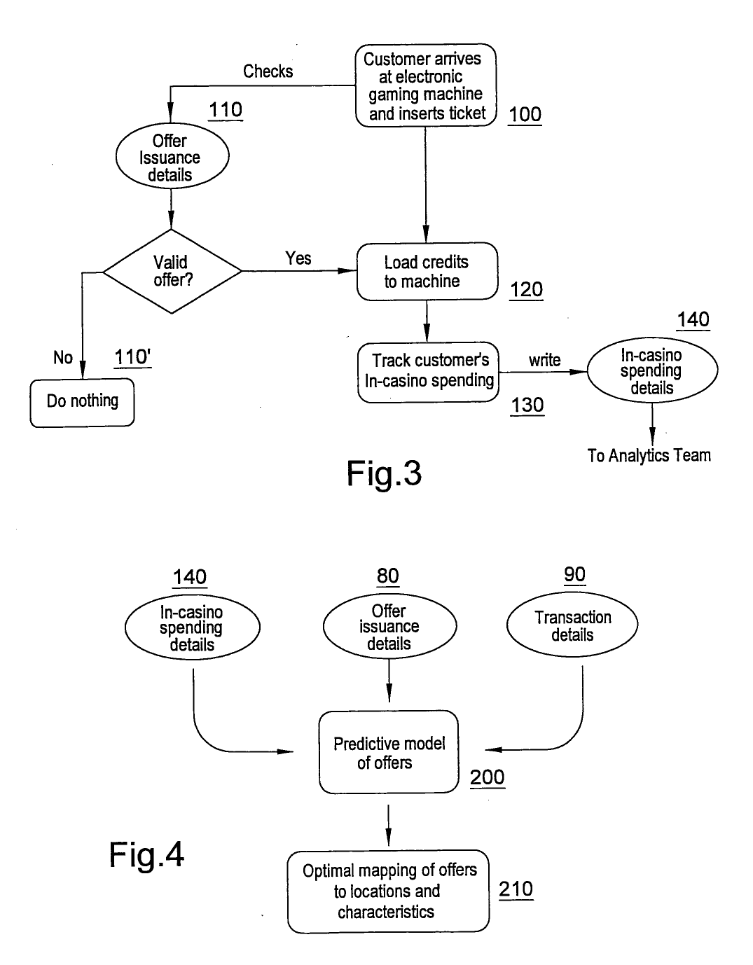

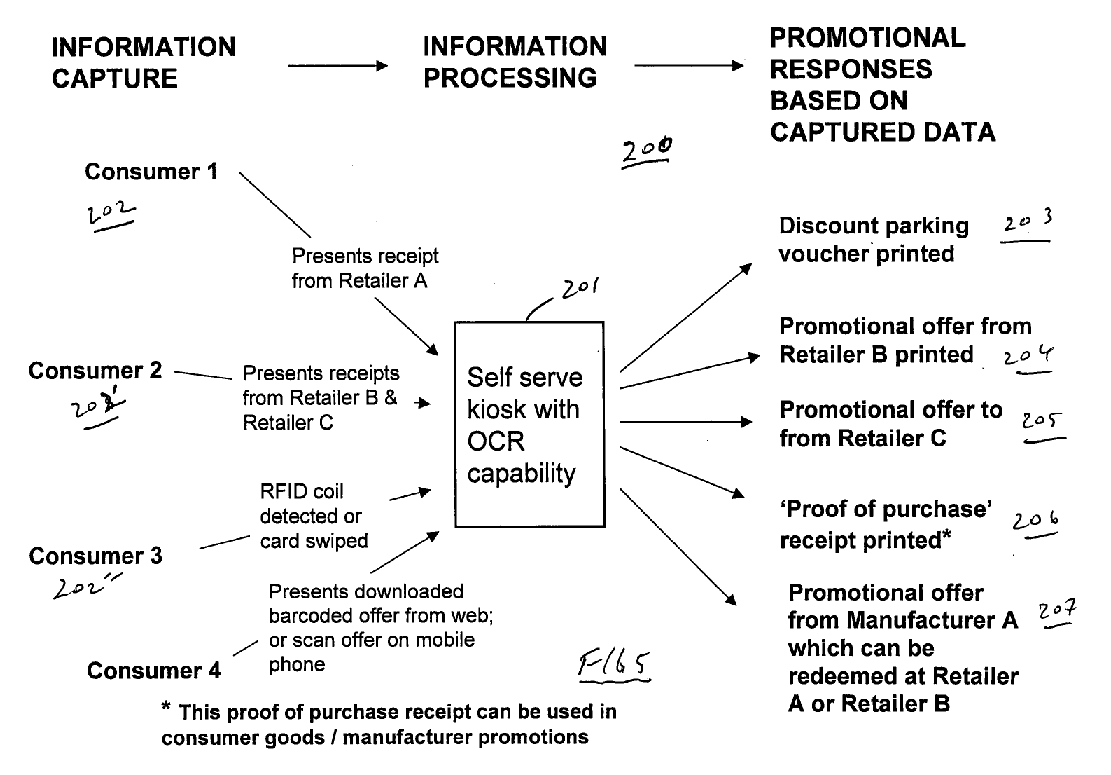

Referring to FIGS. 2 to 4, there are shown flow charts of actions at the POS (FIG. 2), gaming apparatus (which in the specific embodiment is located in a casino) FIG. 3, and actions taken in a back office to determine the level or financial amount of the reward which can be offered to a particular customer for a particular POS transaction (FIG. 4).

In FIG. 2, as a first step 10, the application is loaded onto an in-store (retail outlet) POS 1, there being a virtual COM port created if necessary. In the second step 20, the customer arrives at the POS 1 and is optionally identified. Details are written electronically at the second step 20 to FIG. 4. At a third step 30 the item(s) 5 subject of the transaction is or are scanned by the scanner 4 the final transaction being totalled and payment made at the fourth step 40.

Steps 20 and 30 trigger a check rule set in step 50 and the application determines if an offer of a reward is triggered. If the answer is ‘No’, the system keeps “listening” to gather information about the instantaneous transaction being carried out, step 60.

If the offer of a reward is triggered step 70, the dedicated printer device 7 prints the ticket, coupon or receipt. The offer of the reward details, step 80, is provided by the software application via for example, an internet comms device, to the casino and analytics back room (FIG. 4), together with the transaction details 90, which are written via steps 20, 30 and 40. It will be understood that the information relating to reward attributes is communicated from the software application (whether installed on the retailer's POS 3 or on an external device such as a fanless PC linked to the POS device). Thus the more details provided, the more the application can be refined to determine the optimum reward for optimum ‘spend’ in the casino. At the casino (FIG. 3) the customer having the reward arrives at the gaming apparatus, step 100, which is electronic, with his or her ticket, coupon or receipt and inserts it into or has it read by the gaming apparatus. Checks of offer issuance details are made, 110, and authenticated, or otherwise. If “otherwise”, nothing further transpires, step 110′. If the reward is authenticated, valid and is thus to be redeemed, credit in the amount of the reward is loaded into the gaming apparatus, 120, and the customer plays the game. The total customer “spend” is tracked, step 130 and details thereof are forwarded to the means to provide the optimum reward to be offered based on transaction details (from FIG. 2), in-casino spending details, 140 (FIG. 3) and the offer issuance details to provide a predictive model of offers of reward to be made, 200, which in turn provides an optimal mapping of offers of rewards to locations (POS) and transaction details which provide the application at a particular point of sale 210.

Using the invention described with reference to the drawings, the system and method comprise:

### A. An In-Store Component (Retail Outlet), (FIGS. 1, 2)

1. The conduct and potential recording of the key details of a retail transaction using a POS device.
2. The printing of an offer, dependent on certain characteristics of the transaction, and the recording of that offer, linking it to the retail transaction.
   B. (Gaming Apparatus) (FIG. 3) (a Component which can be In-Casino)
3. The redemption of that offer via its insertion into a gaming device and the recording of that redemption.
4. The tracking of the in-casino behaviour of the individual redeeming the offer and the linking of that recorded behaviour to the original retail transaction.

### C. Back Office Analytic Component (Application Determinant) (FIG. 4)

5. The optimal matching of offers to retailers and transactions so as to maximise the value of the resulting in-casino behaviour. The transaction data from the POS device 3 and hence reward attribute information data—it will be understood that the transaction information data which results in printing of the reward is used to calculate the reward to be offered—is transmitted to the ‘back office’ via an internet connected communication device.

### The In-Store Component

### A Typical Retail Transaction

A typical retail transaction involves the following steps:
1. The customer arrives at a point of sale
2. His or her goods are scanned and scanned information is passed to a POS application to process the transaction (optionally, he or she also presents a card for scanning that uniquely identifies him or her)
3. Scanning is finished and a receipt is printed
4. Payment is made and the transaction is complete

This process represents a prime opportunity to present the consumer with an EGM-readable targeted message or offer designed to encourage him or her to patronise a casino, and also, potentially, to play a particular game (which as mentioned hereinbefore can be at a location other than a casino which latter is given as one example).

Offer targeting can be based on any or all of a range of information that is available at the time the transaction takes place, for example:
The nature of the store at which the ‘basket’ is being scanned
The specific contents of the ‘basket’ of goods being scanned
The total value of the ‘basket’
The store at which the transaction is taking place
The time, date and day of week on which the transaction is taking place
Some characteristic of the customer if he or she is identified as part of the transaction and such identification allows additional information to be associated with the transaction

With judicious use of such information, the offer or message that is presented to the consumer can be made highly relevant to his or her individual circumstances. Further, by employing sophisticated statistical analyses the level of relevance—measured by the level of redemption and subsequent in-casino spend—can be raised.

The In-Store Solution as herein described suitably involves the creation of a computer application to run on a retailer's existing Windows POS device.

The application running on the POS device 3 would gather information/data about the current transaction by:
‘listening in’ for or intercepting information being sent to the POS device from the scanner, keyboard or magnetic stripe reader.
This would be triggered by key presses and would involve creating a procedure which hooks into the Windows message queue, and captures any keyboard activity (which includes barcodes scanning and magnetic stripe reading).
Information about barcodes and mag-stripe encoded details would be identified by the speed of entry and would be recorded; all other information (e.g. ordinary usage of the keyboard) would be ignored.
Creating a virtual COM port and, if necessary, configuring the POS device to use a pole display running on that port, then intercepting messages sent to that pole display.
Creation of the virtual COM port would require a serial port bridge driver (e.g. “ComEmulDrv”).
Information about product descriptions, quantities, prices and transaction totals would be identified by numeric values and would be recorded along with the item description also being displayed; all other information (e.g. “Welcome to Our Store” and “Thank you”) would be discarded.
Where the retailer was already using a pole display, the POS application will be configured to send pole display messages to the virtual serial port, and the system will then pass on (after having recorded product descriptions, quantities, prices and transaction totals) the unchanged stream of data to the original pole display.
Where the retailer was not already using a pole display, the POS application will be configured to treat the virtual COM port as though a pole display was connected, but the system will not pass the data stream on.

In summary there are provided three methods of intercepting transaction data, they are: 1. hooking into the message queue, 2. intercepting information from a virtual pole display, and 3. where necessary, creating a virtual COM port. The first step is generally taken in combination with, or to be supported by, step 2 or step 3, as the transaction data string intercepted from the Windows message queue does not contain the item description, which the pole display or another virtual COM port does. It is also possible to intercept a VGA (video graphics array) data stream on its way to the output screen, as a result of which it is possible to capture data from a POS, PC or EGM in a relatively unobtrusive way, via a VGA connector/port (or via a cable linking the screen and a processor). This is achieved using a VGA splitter/booster, which is combined with a capture device (tiny PC with wireless). This provides a relatively simple reporting system for EGMs (electronic gaming machines).

Alternatively, if the application detects that it cannot directly collect such information (being unable to find any textual information after traversing the window hierarchy), a logical snapshot of the image being displayed is taken and then, via standard Optical Character Recognition algorithms (Tesseract OCR), the relevant parts of that image are converted into their text equivalents.

Moreover, the system is set up to create a unique code means such as a bar code for each reward, which can minimise or prevent fraud, and link the redemption event and associated behaviour to the transaction information and reward attribute information.

### Triggering an Offer

As well as running the base application, the retailer's POS device 3 can hold on an accessible storage device(s) text and image needed to produce (i.e. print on a dedicated printer) a number of predetermined offers. Each offer of reward will have associated with it the circumstances under which it will be printed. These might be:
The specific day
The current time of day or day of week
The presence in the current basket of a particular item (identified by its associated barcode or by a complete of partial line description)
The total size of the transaction

The application will determine, for each transaction, if an offer should be printed on a ‘first triggered, first printed’ basis. That is, it will respond to the first transaction characteristic that it sees that is associated with a particular offer; it will then print the appropriate offer and print no more offers for that same transaction.

Rulesets—which map transaction characteristics to offers—will be periodically transmitted to POS devices in retail outlets. Also, information on valid coupons is transmitted to the casino.

For the gaming environment, offers will vary with respect to:
The casino(s) or other location in which the promotional offer will be valid
The type and specifics of the offer (how many complimentary credits, on what games, between what dates)
The value of the offer

Such offers could be printed on the retailer's existing receipt printer, but the current solution assumes the availability of a dedicated ticket-printer. There are a number of benefits.
It does not interfere with the retailer's existing receipt-printing
It allows us to tightly control to quality of the printed ticket
It allows coupons to be printed at any time during the transaction, potentially reducing to near zero the impact on the average transaction time.

Offers will be printed on tickets capable of being read in a gaming device. They will carry a unique barcode that encodes key characteristics of the barcode such as where it is valid, for what monetary value and until what date. The uniqueness of the barcode will allow it to be validated and logically cancelled on first redemption.

### Capturing Data

While the transaction is taking place, the in-store application will write information about the transaction to a data store on the POS device. This information will include:
A transaction identifier
A store and POS lane identifier
A time stamp
Every barcode
Every product description and associated quantity and price
The transactional total
Any customer ID extracted from the data stream
An identifier for any offer that was issued.

### B. The In-Casino (or Other Location) Component

Each printed offer of reward will be valid for:
One or more casinos
A specified time period
A specified good or service with a specified (possibly notional) value

To redeem a promotional offer a consumer will be required to insert the issued ticket into gaming apparatus such as an electronic gaming machine (EGM) at one of the designated casinos. A barcode reader within the EGM reads the barcode and initiates a search of the casino database. If the promotional ticket is valid, the complimentary credits are loaded to the machine.

Ideally, the casino will have internal processes that will allow it to track the total in-casino spending of the individual who redeemed the issued ticket. They would then be able to pass back this spend information along with the barcode of the offer with which it was associated.

An internal process which may be used to track in-casino spending is a ticket-in ticket-out system, where the cash output from one machine is a ticket which can then be inserted into another machine. These tickets will identify both the cash amount it represents, along with the value encoded on the original ticket offered at the POS.

### C. The Back Office Analytic Component

For the initial period, ‘triggers’ (i.e. transaction characteristics) will suitably, but not specifically, be matched to offers based on a combination of the following:
random assignment
management judgment about the appropriateness of particular offers at particular locations

The resulting rulesets will then be propagated to the relevant retail outlets, offers of rewards will be issued, some of which will be redeemed and some of which will expire unredeemed.

Once this has occurred, the following information will be available about each issued ticket, coupon or receipt:
the store at which it was issued
the time of day and day of week on which it was issued
details of the transaction as part of which it was issued (i.e. product descriptions, quantities, transaction total and, if available, information about the individual making the transaction)
characteristics of the offer (e.g. casino, game type, face value)
whether or not it was redeemed
the casino in which it was redeemed
the date and time at which it was redeemed
the in-casino spend of the individual who redeemed the offer

From this data a statistical model or models will be fitted that will predict the likely in-casino spend from the issuance of a particular offer at a particular location as part of a particular transaction. There are model types, for example Binary Logistic (if the likelihood of redemption is fitted as a separate model), Ordered Logistic (if in-casino spend is treated as a discrete rather than a continuous variable) and any of a range of classification algorithms including Random Forest and Conditional Random Forest.

With this model those offers can be described that will result in the highest in-casino spend (net of the actual cost of providing the offer) from amongst all the available offers.

In modifications of the invention herein:
1. It is possible to scan receipts, read them by OCR (Optical Character Recognition), converting images of text into characters) and use that as transaction data. Thus a customer (e.g. a patron of say a Casino) can be issued with an EGM-readable ticket from a kiosk located in a retail area of a Casino. The reward (offer) is based on the purchases made (accounting for purchases across multiple outlets) without the need for equipment in individual stores or retail outlets. This provides a behavioural targeting capability as before, using retail transaction data, enhanced by taking into account transactions from multiple outlets, which is advantageous in reducing capital expenditure of deployment as there is no need for linking with a plurality of POS.
2. Patrons (customers) can receive an incentive to ‘register’ their receipts (such as free concert tickets for spending more than US$200), while at the same time being issued a targeted promotional ticket for the EGM based upon their spend patterns.
3. Using an optical capture device housed within a kiosk, barcodes can be read from mobile phones. Therefore, Casinos can make offers to patrons via mobile phones which can be ‘cleared’ (validated) at a kiosk, where an offer on an EGM readable ticket is printed at the same time.

It will be understood that the system of the present invention essentially utilises transactional characteristics, captured by ‘intercepting’ transaction streams at a POS (or another transaction system such as a ferry ticketing machine), to print an offer of reward. In addition to this transaction data, the system is able concurrently to utilise information about an individual (e.g. historical spend patterns, preferred casino) which is encoded in a loyalty card, or is inferable from same. Alternatively, the card has an identifier which serves as the index key for a ‘look up table’ comprising relevant behavioural information. Either way predictive algorithms use transactional characteristics, potentially supplemented by individual information to print an offer of reward.

The system has the ability to:
1. Scan printed transaction receipts;
2. Scan information displayed on mobile communication devices (e.g. mobile phone);
3. Detect electronic identifiers such as RFID tags;
4. Decode the information embedded in 1-3 (e.g. till receipts, ‘digital’ bar codes, and RFID tags);
5. Uses this information, in conjunction with transactional characteristics in order to print an (analytically optimal) offer of reward.

### Scanning Mobile Devices

The point of sale may comprise a device for reading or scanning images displayed on a player's mobile phone or other personal communication device. For example, scanning a bar coded ‘electronic coupon’ or promotional offer displayed on a mobile phone.

Alternatively, a separate device located away from the point of sale (e.g. a self service kiosk) can be used for scanning images or offers displayed on a personal communication device.

These offers or images may have been sent to the player's mobile phone because of their proximity to:
a retail store,
a place of interest (for example, the slot floor of a casino; a transport terminal).

Images (for example, on a bar coded electronic coupon) displayed on the player's mobile phone or other communication device may be encoded with information about the offer itself, or about the player (e.g. their personal characteristics, historical spend patterns, or where they have been).

All part of this encoded information is used, in conjunction with the associated transaction characteristics, for the purpose of printing an offer of reward.

### RFID

A player may carry a RFID tag. For example, the tag may be used as the unique identifier for a loyalty card program. The RFID tag may contain information which can be decoded by the system. It will be appreciated that retail an gaming loyalty program/rewards will increasingly use a RFID tag/coil rather than a card.

### OCR

The system works as follows:
1. Players visiting the retailer or mall (inside or outside a Casino complex) are invited to register their receipts at a self service kiosk;
2. Their individual identity may be recognized by swiping a Casino loyalty card, carrying an RFID readable tag or using some other means of individual identification (a hotel room ‘swipe card’/key);
3. Players are invited to place their docket receipt/s under an optical scanning device, housed within the kiosk;
4. An image of the receipt is captured by the optical scanner such as a Logitech webcam;
5. OCR software is used to decode, from the text: the specific items purchased, their price, time and date of the transaction, retailer store (where the system is deployed in a mall), total price paid, method of payment;
6. An offer of reward is printed for the player to insert in an EGM.

FIG. 5 shows a flow diagram of use of a system 200 embodying the invention using a self-serve kiosk 201 for capturing information from a plurality of consumers (purchasers) 202, 202′, 202″ and providing promotional responses based on information processing at the kiosk 201.

FIG. 6 shows a flow diagram of the overall kiosk-orientated system 200. The application is loaded on the self service kiosk or kiosks 208, the customer (purchaser) arrives, 209, and a receipt (or receipts) is/are issued (210). The results of scanning are sent electronically as transaction details 211 and thence to an analytics team 212, (as at 140 in FIG. 3). The receipts 210 are also directed to a check rule set 213 to verify if a reward offer can be triggered. If it is not, the system keeps listening, as at 60 in FIG. 2. If it is, i.e. ‘yes’, an offer (reward) is printed, and offer issuance details 217 are passed to the analytics team 212. This is similar to 70, 80 in FIG. 2.

FIG. 7 shows a flow diagram of handling of the scanned receipt data 210, which has sub-system 218, detect identifier 219 scan bar coded offer (which can be on paper, downloaded from the world wide web or receivable by mail), or 220, scan offer on mobile phones/or personal communication device. The information passes to a means 221 for decoding, passing, cleaning, transforming and integrating the data, which is then passed to means 222 to provide predictive model offers and then on to means 223 for optimal mapping of the offers to locations and characteristics such as analytics team 212.

It will be understood that although ‘gaming apparatus’ has been referred to herein, the invention described is also applicable to gambling, for example on a roulette wheel, and/or to taking part in a lottery, Lotto or the like, where a reward for use in gambling or taking part can be provided to a potential player via a POS. Moreover, the invention described can be used to provide rewards to holders of loyalty cards, for example to Casino loyalty card-holders.

It will be understood too that “retail outlets” used herein relate to any outlet where a customer goes to conduct a retail transaction, for example, but not limited to a super- or mini-market, a bottle store or off-license, a department store, a boutique, and includes such outlets as ticket dispensers at say a rail, bus, airport or ferry terminal, in other words at any location where a customer makes a transaction.

In summary, where a kiosk is utilised it provides an intelligent ticketing system and cross promotional platform which has:
Interactive, compact self service kiosk;
A touch screen which allows the communication of targeted offers and messages;
Consumer brands can co-fund the platform by purchasing targeted access to consumers;
Has inbuilt TITO/FutureLogic ticket printer;
Can be linked to the POS to enable all transaction data to be captured (without interfering with the POS;
The touchscreen can also be used to capture contact details, or for patron experience surveys.
All promotional offers, promotional credits and data are externally managed;
The system is fully automated. Staff training is minimal;
The system can dynamically print tickets with different promotional credits and offers, based on transaction characteristics (e.g. amount spent, brands purchased), time or location;
Targeting is achieved via the use of sophisticated learning algorithms applied to the transaction and redemption data—in real time.

1. A computer implemented system for providing customers of retail outlet(s) with a transaction based gaining reward, comprising means for respectively determining details of a customer transaction and providing a reward to the customer, means associated with a gaining apparatus for checking validity of a reward presented by a customer, and means for determining the level of reward based at least on analysis of transaction data.

2. A system according to claim 1, comprising a network of said means.

3. A system according to claim 1, the reward being printed on an item selected from a group comprising a ticket, coupon and receipt issued at the point of customer transaction.

4. A system according to a claim 1, the means for determining the level of reward providing mapping of rewards based initially on retail outlet (or point of purchase) location and selected transaction attributes, whereby to provide an offer of a reward based on predictive gaming apparatus spend.

5. A system according to claim 3, the retail outlet including at least one point of sale at which the reward is issued to the customer.

6. A system according to claim 5, comprising a plurality of separate retail outlets, each of which has at least one point of sale at which the reward is issued to the customer.

7. A system according to claim 5, the at least one point of sale comprising a printer adapted to print a ticket, coupon or receipt bearing details of the reward.

8. A system according to claim 6, the details of the reward being encoded in a bar code.

9. A system according to claim 6, the details of the reward being encoded in a magnetic strip.

10. A system according to claim 7, the printer being adapted to print a ticket, coupon or receipt at any point during a transaction at the point of sale.

11. A system according to claim 6, the existing point of sale comprising the said printer as an additional printer dedicated to the provision of a ticket, coupon or receipt.

12. A system according to claim 10, the point of sale comprising a scanner device adapted to initiate means at the point of sale for providing the reward to the customer.

13. A system according to claim 11, the point of sale comprising a device adapted to run a basic application and comprising an accessible drive adapted to hold text and image(s) required to produce an appropriate ticket, coupon or receipt.

14. A system according to claim 13, the accessible drive being adapted to produce a plurality of offers of rewards predetermined by the means for determining the level of reward.

15. A system according to claim 13, adapted, for each transaction, to print an offer of a reward based solely on a first transaction characteristic of a reward.

16. A system according to claim 13, adapted, for each transaction, to print an offer of a reward based on a plurality of transaction characteristics of a reward.

17. A system according to claim 15, the plurality comprising all of the transaction characteristics of the reward.

18. A system according to claim 1, the gaming apparatus being located at or in a casino.

19. A system according to claim 1, applicable to one or a plurality of casinos at the or each of which there is a gaming device adapted to be played using the reward.

20. A system according to claim 18, the casino(s) and retail outlet(s) being remote.

21. A system according to claim 17, the or each gaming apparatus being electronic and adapted to be played using the reward.

22. A system according to claim 21, the gaming apparatus including electronic means to read the bar code or magnetic strip whereby to load a valid offer of a reward into the gaming apparatus for play by the customer.

23. A system according to claim 22, the gaming apparatus comprising means to track the in-casino spend of the customer redeeming the reward.

24. A system according to claim 1, comprising means to intercept a VGA data stream.

25. A system according to claim 1, comprising a kiosk at which information from a transaction is processed.

26. A system according to claim 25, the kiosk including an OCR device.

27. A method of providing a computer-implemented system for providing customers of retail outlet(s) with a transaction based reward, comprising the steps of providing a point of sale and means for respectively determining details of a customer transaction and providing a reward to the customer, providing a gaming apparatus and means associated therewith for checking validity of a reward presented by a customer, and providing means for determining the level of reward to be offered based at least on details of the transaction.
